(19) United States
(12) Patent Application Publication
(10) Pub. No.: US 2026/0258236 A1
(43) Pub. Date: Sep. 3, 2026

(54) COMPOSITION

(71) Applicants: Sumitomo Chemical Company, Limited, Chuo-ku, Tokyo (JP); Newlight Technologies, Inc., Huntington Beach, CA (US)

(72) Inventors: Shunsuke CHIBA, Ichihara-shi, Chiba (JP); Takafumi Seki, Ichihara-shi, Chiba (JP)

(21) Appl. No.: 19/113,615

(22) PCT Filed: Sep. 25, 2023
(86) PCT No.: PCT/JP2023/034742

§ 371 Date: Mar. 20, 2025

(30) Foreign Application Priority Data
Oct. 11, 2022 (JP) 2022-163012

(51) Int. Cl. C08L 23/12; C08K 3/34

(52) U.S. Cl. CPC C08L 23/12; C08K 3/34

(57) ABSTRACT

A composition contains an olefin-based polymer A, an aliphatic polyester-based polymer B, and an inorganic powder C. A pH of the inorganic powder C as evaluated in accordance with JIS M 8016-1991 is 6.5 to 11.5.

### TECHNICAL FIELD

The present invention relates to a composition.

### BACKGROUND ART

An aliphatic polyester-based polymer is a resin that can be synthesized by renewable resources without using fossil resources and has low environmental load, and is a resin excellent in molding processability and mechanical properties. For this reason, by adding the aliphatic polyester-based polymer to various packaging materials, various containers such as bottles, food packaging materials, container caps, stationery, daily goods, fibers for carpets and sofas, interior and exterior materials for automobiles, electrical and electronic components, building materials such as interior materials for buildings and houses, and the like, the environmental load can be reduced.

As a composition containing such an aliphatic polyester-based polymer, a composition described in Patent Literatures 1 to 3 is known.

### CITATION LIST

### Patent Literature

Patent Literature 1: Japanese Unexamined Patent Publication No. 2008-239858
Patent Literature 2: Japanese Unexamined Patent Publication No. 2006-241445
Patent Literature 3: Japanese Unexamined Patent Publication No. 2019-178206

### SUMMARY OF INVENTION

### Technical Problem

However, in a conventional composition containing an aliphatic polyester-based polymer, odor may be generated from a molded body after molding.

The present invention has been made in view of the above problems, and an object thereof is to provide a composition capable of reducing generation of odor after molding while containing an aliphatic polyester-based polymer.

### Solution to Problem

[1] A composition containing: an olefin-based polymer A; an aliphatic polyester-based polymer B; and an inorganic powder C, in which a pH of the inorganic powder C as evaluated in accordance with JIS M 8016-1991 is 6.5 to 11.5.
[2] The composition described in [1], in which the inorganic powder C does not contain a fatty acid metal salt.
[3] The composition described in [2], in which the aliphatic polyester-based polymer B is a poly(3-hydroxyalkanoate)-based polymer having a melting point of 150° C. or higher.
[4] The composition described in any one of [1] to [3], in which the pH of the inorganic powder C as evaluated in accordance with JIS M 8016-1991 is 8.5 to 9.5.
[5] The composition described in any one of [1] to [4], in which a median diameter D50 of a weight-based particle size distribution of the inorganic powder C as measured by a laser diffraction method is 0.05 to 30 μm.
[6] The composition described in [1] to [5], in which a content of the olefin-based polymer A is 51 to 99.9 parts by mass and a content of the aliphatic polyester-based polymer B is 0.1 to 49 parts by mass with respect to 100 parts by mass of the total of the olefin-based polymer A and the aliphatic polyester-based polymer B.
[7] The composition described in any one of [1] to [6], in which a content of the inorganic powder C is 0.1 to 40 parts by mass with respect to 100 parts by mass of the total of the polymer A and the polymer B.
[8] The composition described in any one of [1] to [7], in which the content of the aliphatic polyester-based polymer B is 0.1 to 20 parts by mass.
[9] The composition described in any one of [1] to [8], in which the olefin-based polymer A is a propylene-based polymer.
[10] The composition described in any one of [1] to [9], in which when a melt mass flow rate of the aliphatic polyester-based polymer B as measured under conditions of a temperature of 210° C. and a load of 2.16 kgf is designated as MFR (B), and
a melt mass flow rate of a mixture X containing 0.5 parts by mass of the inorganic powder C with respect to 100 parts by mass of the total of the aliphatic polyester-based polymer B and the inorganic powder C as measured under conditions of a temperature of 210° C. and a load of 2.16 kgf is designated as MFR (X), MFR (X)/MFR (B) is 1.0 or less.

### Advantageous Effects of Invention

According to the present invention, there is provided a composition capable of reducing generation of odor after molding while containing an aliphatic polyester-based polymer.

### DESCRIPTION OF EMBODIMENTS

Hereinafter, some embodiments of the present invention will be described in detail. However, the present invention is not limited to the following embodiments.

### (Composition)

A composition according to an embodiment of the invention contains an olefin-based polymer A, an aliphatic polyester-based polymer B, and an inorganic powder C.

### <Olefin-Based Polymer A>

The olefin-based polymer A is a polymer containing 50 mass % or more of a structural unit derived from an olefin having 2 or more and 10 or less carbon atoms (provided that, the total amount of the olefin-based polymer is taken as 100 mass %). Examples of the olefin having 2 or more and 10 or less carbon atoms include ethylene, propylene, 1-butene, 4-methyl-1-pentene, 1-hexene, 1-octene, and 1-decene.

The olefin-based polymer A may contain a structural unit derived from a monomer except olefins having 2 or more and 10 or less carbon atoms. Examples of the monomer except olefins having 2 or more and 10 or less carbon atoms include aromatic vinyl monomers such as styrene; unsaturated carboxylic acids such as acrylic acid and methacrylic acid; unsaturated carboxylic acid esters such as methyl acrylate, ethyl acrylate, butyl acrylate, methyl methacrylate, and ethyl methacrylate; vinyl ester compounds such as vinyl acetate; conjugated dienes such as 1,3-butadiene and 2-methyl-1,3-butadiene (isoprene); and non-conjugated dienes such as dicyclopentadiene and 5-ethylidene-2-norbornene.

The olefin-based polymer A can be at least one selected from the group consisting of an ethylene-based polymer, a propylene-based polymer, and a butene-based polymer, and may be a combination of any two or more kinds thereof.

An ethylene-based polymer is a polymer containing 50 mass % or more of a structural unit derived from ethylene, and examples thereof include an ethylene homopolymer, an ethylene-1-butene copolymer, an ethylene-1-hexene copolymer, an ethylene-1-octene copolymer, and an ethylene-1-butene-1-hexene copolymer. The ethylene-based polymer may be a combination of two or more ethylene-based polymers.

A propylene-based polymer is a polymer containing 50 mass % or more of a structural unit derived from propylene, and examples thereof include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer. The propylene-based polymer may be a combination of two or more kinds of propylene-based polymers. It is suitable that the olefin-based polymer A is a propylene-based polymer.

A butene-based polymer is a polymer containing 50 mass % or more of a structural unit derived from 1-butene, and examples thereof include a 1-butene homopolymer, a 1-butene-ethylene copolymer, a 1-butene-propylene copolymer, a 1-butene-1-hexene copolymer, a 1-butene-1-octene copolymer, a 1-butene-ethylene-propylene copolymer, a 1-butene-ethylene-1-hexene copolymer, a 1-butene-ethylene-1-octene copolymer, a 1-butene-propylene-1-hexene copolymer, and a 1-butene-propylene-1-octene copolymer. The butene-based polymer may be a combination of two or more kinds of butene-based polymers.

The olefin-based polymer A can be produced by using a known polymerization method using a known polymerization catalyst.

The melt mass flow rate (MFR) of the olefin-based polymer A as measured according to JIS K7210-2014 under conditions of a temperature of 230° C. or 190° C. and a load of 2.16 kgf is preferably 0.1 g/10 min or more and 200 g/10 min or less.

### <Aliphatic Polyester-Based Polymer B>

The aliphatic polyester-based polymer has a structure of a polycondensate of an aliphatic polyvalent carboxylic acid component and an aliphatic polyhydric alcohol component or a polycondensate of an aliphatic hydroxycarboxylic acid, and the main chain of the repeating unit does not contain an aromatic hydrocarbon structure.

Examples of the aliphatic polyester-based polymer include a polymer of a hydroxycarboxylic acid or a lactone, a polycondensate of a diol and a dicarboxylic acid, and a copolymer thereof. When the polymer B is a copolymer, the form of arrangement of the copolymer may be any form of a random copolymer, an alternating copolymer, a block copolymer, a graft copolymer, and the like.

Furthermore, those may be one in which at least a part thereof is crosslinked with a crosslinking agent such as a polyvalent isocyanate, such as xylylene diisocyanate or 2,4-tolylene diisocyanate, or a polysaccharide, such as cellulose, acetyl cellulose, or ethyl cellulose. Further, those may be one in which at least a part thereof may have any structure of linear, cyclic, branched, star, three-dimensional network structures, and the like, there is no any limitation, and those may be a copolymer with a polyolefin-based resin or a graft polymer with a polyolefin-based resin.

Furthermore, this aliphatic polyester-based polymer B can be used singly or in combination.

Examples of the hydroxycarboxylic acid include a hydroxycarboxylic acid having 2 to 18 carbon atoms, a hydroxycarboxylic acid having 6 or less carbon atoms is preferable, and a hydroxycarboxylic acid having 4 carbon atoms is most preferable. Specific examples thereof include glycolic acid, L-lactic acid, D-lactic acid, D,L-lactic acid, 3-hydroxybutyrate, 3-hydroxyvalerate, 3-hydroxypropionate, 4-hydroxybutyrate, 4-hydroxyvalerate, 5-hydroxyvalerate, 3-hydroxypentenoate, 3-hydroxyhexanoate, 3-hydroxyheptanoate, 3-hydroxyoctanoate, 3-hydroxynonanoate, and 3-hydroxydecanoate.

Examples of the lactone include propiolactone, butyrolactone, valerolactone, caprolactone, and laurolactone.

The diol is preferably a diol having 2 to 10 carbon atoms. In particular, an aliphatic diol having 2 to 4 carbon atoms or an alicyclic diol having 5 to 6 carbon atoms is more preferable. Specific examples thereof include ethylene glycol, 1,3-propanediol, 1,4-butanediol, 1,2-butanediol, 1,5-pentanediol, 1,6-hexanediol, 1,8-octanediol, 1,10-decanediol, 1,12-dodecanediol, 1,14-tetradecanediol, 1,16-hexadecanediol, 1,18-octadecanediol, 1,2-cyclohexanediol, 1,4-cyclohexanediol, 1,2-cyclohexanedimethylol, and 1,4-cyclohexanedimethylol.

The dicarboxylic acid is preferably an aliphatic dicarboxylic acid having 2 to 12 carbon atoms. In particular, an aliphatic dicarboxylic acid having 2 to 6 carbon atoms or an alicyclic dicarboxylic acid having 5 to 6 carbon atoms is more preferable. Specific examples thereof include oxalic acid, malonic acid, succinic acid, glutaric acid, adipic acid, pimelic acid, suberic acid, azelaic acid, sebacic acid, undecadicarboxylic acid, dodecadicarboxylic acid, 1,14-tetradecanedicarboxylic acid, 1,16-hexadecanedicarboxylic acid, 1,18-octadecanedicarboxylic acid, a dimer acid and a hydrogenated product thereof, hexahydrophthalic acid, hexahydroisophthalic acid, and hexahydroterephthalic acid. Furthermore, these dicarboxylic acids may be derivatives such as an alkyl ester having 1 to 4 carbon atoms and an acid anhydride.

Among the aliphatic polyester-based polymers, it is preferable to use polylactic acid or polybutylene succinate, poly(butylene succinate-co-butylene adipate), polycaprolactone, poly(3-hydroxybutyrate), poly(3-hydroxybutyrate-co-3-hydroxyhexanoate), and polyglycolic acid.

When polylactic acid is used as the aliphatic polyester-based polymer B, the polylactic acid is preferably one in which the proportion of the L-form in the lactic acid component constituting the polylactic acid is preferably 94 mol % or more. By setting the proportion of the L-form in such a range, it is possible to prevent a decrease in melting point.

(Poly(3-hydroxyalkanoate)-Based Polymer)

The polymer B can be a poly(3-hydroxyalkanoate)-based polymer having a melting point of 150° C. or higher.

The poly(3-hydroxyalkanoate)-based polymer is a polyhydroxyalkanoate, that is, a polycondensate (polyester) of a hydroxyalkanoic acid, and necessarily contains a repeating unit of a 3-hydroxyalkanoate represented by formula (1). In formula (1), R is a hydrogen atom, a halogen atom, an alkyl group having 1 to 15 carbon atoms, a cyano group, an amino group having 1 to 11 carbon atoms, an alkoxy group (alkyloxy group) having 1 to 11 carbon atoms, an amide group having 2 to 20 carbon atoms, an aryl group having 6 to 12 carbon atoms, or a monovalent heterocyclic group having 1 to 9 carbon atoms. These groups may have a substituent. In particular, from the viewpoint of compatibility with a component (for example, the polymer A) except the polymer B contained in the composition, R is preferably an alkyl group having 1 to 8 carbon atoms, an amide group having 1 to 20 carbon atoms, or an aryl group having 6 to 8 carbon atoms.

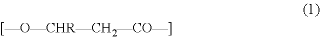

Examples of the halogen atom include F, Cl, Br, and I.

The alkyl group having 1 to 15 carbon atoms may be linear or branched. The number of carbon atoms of the alkyl group is preferably 1 to 8 and more preferably 1 to 4. Examples of the alkyl group include a methyl group, an ethyl group, a propyl group, an isopropyl group, a butyl group, an isobutyl group, a sec-butyl group, a tert-butyl group, a pentyl group, an isopentyl group, a 2-methylbutyl group, a 1-methylbutyl group, a hexyl group, an isohexyl group, a 3-methylpentyl group, a 2-methylpentyl group, a 1-methylpentyl group, a heptyl group, an octyl group, an isooctyl group, a 2-ethylhexyl group, a 3,7-dimethyloctyl group, a nonyl group, a decyl group, an undecyl group, a dodecyl group, a tetradecyl group, and a pentadecyl group.

Examples of the amino group having 1 to 18 carbon atoms include an amino group, an alkylamino group, a dialkylamino group, an arylamino group, an alkylarylamino group, a benzylamino group, and a dibenzylamino group.

Examples of the alkylamino group include a methylamino group, an ethylamino group, a propylamino group, a butylamino group, a pentylamino group, a hexylamino group, a heptylamino group, an octylamino group, a nonylamino group, a decylamino group, a dodecylamino group, an isopropylamino group, an isobutylamino group, an isopentylamino group, a sec-butylamino group, a tert-butylamino group, a sec-pentylamino group, a tert-pentylamino group, a tert-octylamino group, a neopentylamino group, a cyclopropylamino group, a cyclobutylamino group, a cyclopentylamino group, a cyclohexylamino group, a cycloheptylamino group, a cyclooctylamino group, a 1-adamantamino group, and 2-adamantamino group.

Examples of the dialkylamino group include a dimethylamino group, a diethylamino group, a dipropylamino group, a dibutylamino group, a dipentylamino group, a diisopropylamino group, a diisobutylamino group, a diisopentylamino group, a methylethylamino group, a methylpropylamino group, a methylbutylamino group, a methylisobutylamino group, a dicyclopropylamino group, a pyrrolidino group, a piperidino group, and a piperazino group.

Examples of the arylamino group include an anilino group, a 1-naphthylamino group, a 2-naphthylamino group, an o-toluidino group, a m-toluidino group, a p-toluidino group, a 1-fluoreneamino group, a 2-fluoreneamino group, a 2-thiazoleamino group, and a p-terphenylamino group.

Examples of the alkylarylamino group include an N-methylanilino group, an N-ethylanilino group, an N-propylanilino group, an N-butylanilino group, an N-isopropylanilino group, and an N-pentylanilino group.

Examples of the alkoxy group having 1 to 11 carbon atoms include a methoxy group, an ethoxy group, a propoxy group, an isopropoxy group, a butoxy group, an isobutoxy group, a sec-butoxy group, a tert-butoxy group, a cyclopropoxy group, a cyclobutoxy group, and a cyclopentoxy group.

The “amide group” means a group obtained by removing one hydrogen atom bonded to a nitrogen atom from a carboxylic amide. Examples of the amide group having 1 to 20 carbon atoms include a group represented by —NH—C(═O)—R^{A} (provided that, R^{A} is a hydrogen atom or a monovalent organic group) such as a formamide group, an acetamide group, a propionamide group, a butylamide group, a benzamide group, a trifluoroacetamide group, or a pentafluorobenzamide group, and a group represented by —N(—C(═O)—R^{A}) (—C(═O)—R^{B}) (provided that, R^{A} and R^{B} are each independently a hydrogen atom or a monovalent organic group) such as a diformamide group, a diacetamide group, a dipropioamide group, a dibutyroamide group, a dibenzamide group, a ditrifluoroacetamide group, or a dipentafluorobenzamide group. The organic group can be an alkyl group, an alkoxy group, or an aryl group which may be substituted with a halogen atom. Among them, the amide group is preferably a formamide group, an acetamide group, a propionamide group, a butyroamide group, or a benzamide group.

Examples of the aryl group having 6 to 12 carbon atoms include a phenyl group, a tolyl group, a xylyl group, a naphthyl group, and a biphenyl group, and among them, a phenyl group, a tolyl group, and a xylyl group are more preferable.

Examples of the heteroatom of the monovalent heterocyclic group having 1 to 9 carbon atoms include N, O, and S, may be saturated or unsaturated, may have a single heteroatom or a plurality of heteroatoms, and may have different types of heteroatoms. Examples of such a heterocyclic group include a thienyl group, a pyrrolyl group, a furyl group, a pyridyl group, a piperidinyl group, a quinolinyl group, an isoquinolinyl group, a pyrimidinyl group, a triazinyl group, and a thiazolyl group.

The repeating unit of the aliphatic polyester-based polymer B may consist only of one or more kinds of 3-hydroxyalkanoate represented by formula (1), and may have one or more kinds of 3-hydroxyalkanoate represented by formula (1) and one or more kinds of other hydroxyalkanoates.

The aliphatic polyester-based polymer B preferably contains 50 mol % or more, more preferably 70 mol % or more, of the repeating unit of 3-hydroxyalkanoate represented by formula (1) with respect to the total repeating unit (100 mol %) of the hydroxyalkanoate.

Examples of the 3-hydroxyalkanoate represented by formula (1) include, when R is a hydrogen atom or an alkyl group represented by CₙH₂ₙ₊₁ and n is an integer of 1 to 15, 3-hydroxybutyrate with n=1 (hereinafter, sometimes referred to as 3HB), 3-hydroxyvalerate with n=2 (hereinafter, sometimes referred to as 3HV), 3-hydroxyhexanoate with n=3 (hereinafter, sometimes referred to as 3HH), 3-hydroxyoctanoate with n=5, 3-hydroxyoctadecanoate with n=15, and 3-hydroxypropionate in which R is a hydrogen atom.

Examples of the polymer B having only one repeating unit represented by formula (1) include poly(3-hydroxybutyrate) (hereinafter, sometimes referred to as P3HB).

Examples of the polymer B having only a plurality of repeating units represented by formula (1) include poly(3-hydroxybutyrate-co-3-hydroxyhexanoate) (hereinafter, sometimes referred to as P3HB3HH), poly(3-hydroxybutyrate-co-3-hydroxyvalerate) (hereinafter, sometimes referred to as P3HB3HV), and poly(3-hydroxybutyrate-co-3-hydroxypropionate (hereinafter, sometimes referred to as P3HB3HP).

Examples of the other hydroxyalkanoates except the 3-hydroxyalkanoate represented by formula (1) include a repeating unit represented by formula (2) (wherein R¹ is a hydrogen atom or an alkyl group represented by CₙH₂ₙ₊₁, n is an integer of 1 or more and 15 or less, and m is an integer of 2 to 10).

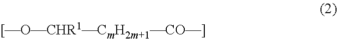

Examples of the polymer B containing repeating units of formula (1) and formula (2) include poly(3-hydroxybutyrate-co-4-hydroxybutyrate) (for example, the following formula (P3HB4HB)).

From the viewpoint of increasing the melting point, it is preferable that the repeating unit of the aliphatic polyester-based polymer B contains at least 3-hydroxybutyrate among 3-hydroxyalkanoate represented by formula (1).

The aliphatic polyester-based polymer B preferably contains 50 mol % or more, more preferably 70 mol % or more, of the repeating unit of 3-hydroxybutyrate with respect to the total repeating unit (100 mol %) of the hydroxyalkanoate.

The aliphatic polyester-based polymer B may have two or more repeating units of ester, and may be, for example, a di-polymer having two repeating units as described above, a tri-copolymer having three repeating units, and a tetra-copolymer having four repeating units.

Examples of the tri-copolymer include poly(3-hydroxybutyrate-co-3-hydroxyvalylate-co-3-hydroxyhexanoate) (hereinafter, sometimes referred to as (P3HB3HV3HH)).

As described above, the aliphatic polyester-based polymer B preferably contains 3-hydroxybutyrate among the repeating unit of the 3-hydroxyalkanoate represented by formula (1). A ratio XX of the repeating unit of 3-hydroxybutyrate to 100 mol of the ester repeating unit of the total hydroxyalkanoate is preferably 90 mol % or more, more preferably 95 mol % or more, and still more preferably 98.0 mol % or more.

The ratio XX is usually 100 mol % or less, preferably 99.9 mol % or less, and preferably 99.8 mol % or less.

The form of arrangement of the copolymer may be any form of a random copolymer, an alternating copolymer, a block copolymer, a graft copolymer, and the like.

The aliphatic polyester-based polymer B may have other ester repeating units except those of formula (1) and formula (2), but the main chain of the other ester repeating units does not contain an aromatic hydrocarbon structure. That is, the aliphatic polyester-based polymer B is an aliphatic polyester. However, it is possible that a group having an aromatic hydrocarbon group is bonded to carbon in the main chain of the other ester repeating unit.

As described in L. Tripathi., M. C. Factories, 11, 44 (2012), the composition ratio of the repeating unit in the aliphatic polyester-based polymer B can be determined by calculation from the results of NMR measurement such as 1H-NMR and 13C-NMR.

Furthermore, the aliphatic polyester-based polymer B may be a mixture of two or more polymers of a poly(3-hydroxyalkanoate)-based polymer.

The weight average molecular weight (Mw) of the aliphatic polyester-based polymer B can be 10000 to 1000000, and is preferably 20000 to 800000 and more preferably 30000 to 600000. When the weight average molecular weight (Mw) is 10000 or more, a molded body excellent in impact strength and tensile elongation can be obtained. Furthermore, when the weight average molecular weight is 500000 or less, the dispersibility in the olefin-based polymer A is improved. The weight average molecular weight may be 400000 or less, 300000 or less, 200000 or less, or 100000 or less. Note that, in the present specification, the weight average molecular weight (Mw) is measured by GPC using standard polystyrene as a molecular weight standard substance.

The aliphatic polyester-based polymer B is a thermoplastic resin, and is suitably crystalline.

The melt mass flow rate (MFR (B)) of the aliphatic polyester-based polymer B as measured according to JIS K7210-2014 under conditions of a temperature of 190° C. or 170° C. and a load of 2.16 kgf is preferably 0.1 g/10 min or more and 200 g/10 min or less. The MFR (B) may be 1 g/10 min or more, 3 g/10 min or more, 5 g/10 min or more, 7 g/10 min or more, 8 g/10 min or more, 10 g/10 min or more, or 20 g/10 min or more. The MFR (B) may be 150 g/10 min or less or 100 g/10 min or less.

The melting point (Tm) of the aliphatic polyester-based polymer B is preferably 150° C. or higher, and may be 155° C. or higher, 160° C. or higher, 165° C. or higher, 170° C. or higher, or 175° C. or higher. The melting point (Tm) of the polymer B can be 220° C. or lower, and may be 200° C. or lower or 190° C. or lower.

The melting point (Tm) of the aliphatic polyester-based polymer B is measured by the position of a main peak based on melting of a crystal obtained by differential scanning calorimetry (DSC) measurement in accordance with JIS K7121.

The poly(3-hydroxyalkanoate)-based polymer may be produced by microorganisms, and may be derived from a compound (such as a cyclic lactone) derived from a petroleum or plant source.

In the poly(3-hydroxyalkanoate)-based polymer, each repeating unit of the hydroxyalkanoate may consist of only the D-form (R-form) as in the case of a polymer produced from a microorganism, or the repeating unit of the hydroxyalkanoate may include both the D-form (R-form) and the L-form (S-form) as in the case of a polymer derived from a mixture of the D-form (R-form) and the L-form (S-form).

In a poly(3-hydroxyalkanoate)-based polymer produced from a microorganism, the repeating unit of formula (1) can be expressed as in the following formula. In formula (BI-1), n represents the degree of polymerization.

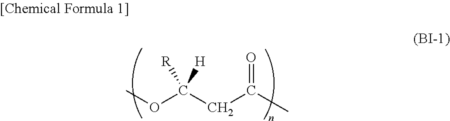

Further, for example, poly-(3-hydroxybutyrate) produced from a microorganism has the structure as described below. In formula (BI-2), n represents the degree of polymerization.

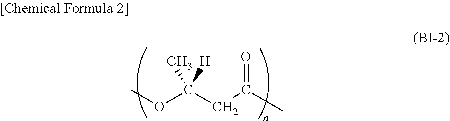

Furthermore, poly-(3-hydroxybutyrate-co-3-hydroxyhexanoate) produced from a microorganism has the structure as described below. In formula (BI-3), m and n represent the degree of polymerization.

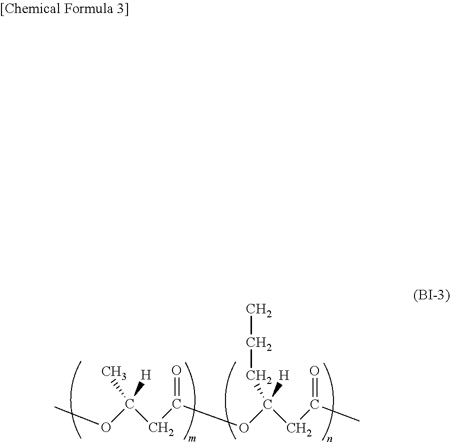

Furthermore, poly-(3-hydroxybutyrate-co-4-hydroxybutyrate) produced from a microorganism has the structure as described below. In formula (BI-4), m and n represent the degree of polymerization.

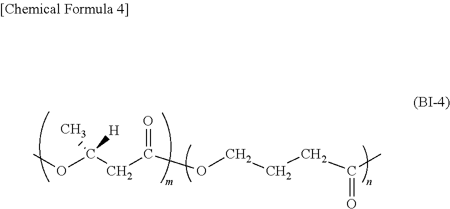

The aliphatic polyester-based polymer B can be biodegradable.

For example, the poly(3-hydroxyalkanoate)-based polymer can be produced by microorganisms such as Alcaligenes eutrophus AC32 strain in which PHA synthase enzyme gene derived from Aeromonascaviae was introduced into Alcaligeneseutrophus (international deposit under the Budapest Treaty, international depositary authority: National Institute of Advanced Industrial Science and Technology Center (Center 6, 1-1-1 Higashi, Tsukuba City, Ibaraki Prefecture, Japan), original deposit date: Aug. 12, 1996, transferred on Aug. 7, 1997, accession number FERMBP-6038 (transferred from original deposit FERMP-15786)) (J. Bacteriol., 179, 4821 (1997)).

### (Inorganic Powder C)

The inorganic powder refers to a powder of an inorganic material. Examples of the inorganic material include a simple substance of a metal or a metalloid, an alloy of two or more elements selected from the group consisting of a metal and a metalloid, and a compound such as an oxide, a sulfide, a nitride, a hydroxide, or a salt (sulfate, phosphate, or the like) containing one element or two or more elements selected from the group consisting of a metal and a metalloid.

Examples of the metal constituting the inorganic material include Al, Li, Ti, Fe, Mg, K, Na, Ca, Zn, Pb, Cu, Cr, Ba, Rb, Cs, Mn, V, Be, Ni, and Co. Examples of the metalloid include Si and B. Furthermore, in the present specification, the inorganic material may be carbon.

The inorganic material may be a natural mineral or may be artificially synthesized. The powder of the inorganic material may be surface-modified.

The pH of the inorganic powder C as evaluated in accordance with JIS M 8016-1991 is 6.5 to 11.5. The pH of the inorganic powder C as evaluated in accordance with JIS M 8016-1991 may be 8.5 or more and 9.5 or less.

The pH of the inorganic powder C is obtained by charging 20 g of the inorganic powder C into 80 mL of pure water, stirring the mixture, and measuring the pH of the liquid.

Note that the pH of the inorganic powder C is determined by the state of the surface of an inorganic powder, that is, a surface functional group. Therefore, in the case of the inorganic powder such as talc exemplified in the present embodiment, the pH does not necessarily fall within a range of 6.5 to 11.5, and the pH of the inorganic powder changes depending on the production method of the inorganic powder, the presence or absence of surface treatment, the type of treatment agent, and the like.

The inorganic powder C may be a powder of a single simple substance or compound in which the pH of the inorganic powder is 6.5 to 11.5, or may be a mixture of powders of two or more materials selected from the group consisting of a simple substance and a compound in which the pH of the inorganic powder C is 6.5 to 11.5.

Examples of the inorganic powder C include at least one selected from the group consisting of a glass bead, a glass balloon, a glass flake, asbestos, mica, a calcium-based compound, talc, silica, calcium silicate, hydrotalcite, titanium oxide, kaolinite, wollastonite, diatomaceous earth, graphite, pumice, and barium sulfate.

Among them, the inorganic powder C preferably includes at least one selected from the group consisting of mica, a calcium-based compound, talc, silica, hydrotalcite, and wollastonite, more preferably includes at least one selected from the group consisting of mica, a calcium-based compound, talc, silica, and hydrotalcite, and still more preferably includes at least one selected from the group consisting of mica, a calcium-based compound, and talc.

Examples of the mica include muscovite, aluminoceladonite, ferro-aluminoceladonite, celadonite, ferro-celadonite, roscoelite, Chromphyllite, Boromuscovite, paragonite, Nanpingite, tobelite, annite, phlogopite, siderophyllite, eastonite, shirozulite, Hendricksite, Montdorite, Yangzhumingite, Tainiolite, polylithionite, trilithionite, Masutomilite, Norrishite, tetra-ferri-annite, tetra-ferriphlogopite, Aspidolite, Preiswerkite, Ephesite, margarite, Chernykhite, clintonite, Bityite, Anandite, kinoshitalite, fluorokinoshitalite, illite, glauconite, Brammallite, Wonesite, biotite, lepidolite, and zinnwaldite.

Examples of the muscovite include muscovite (A-11, A-21S, AB-25S, J-31M, or SYA-21R) manufactured by YAMAGUCHI MICA CO., LTD.

Examples of the calcium-based compound include calcium ascorbate, calcium sulfite, calcium bisulfite, calcium monophosphate, Egyptian Blue, calcium chloride, calcium chloride hydroxide, calcium chlorate, calcium peroxide, casein phosphopeptide, Kalimate, single superphosphate, calcium cyanamide, calcium formate, calcium gluconate, calcium glutamate, calcium chromate, chromium tin pink, calcium silicate, anhydrite, calcium acetate, calcium oxide, calcium hypochlorite, calcium cyanide, calcium bromide, triple superphosphate, calcium oxalate, calcium bromate, calcium tartrate, calcium nitrate, calcium hydroxide, calcium hydride, gypsum, calcium carbide, calcium carbonate, calcium bicarbonate, calcium titanate, calcium lactate, tricalcium diphosphate, calcium fluoride, POs-Ca, polycarbophil calcium iodide, calcium iodide, calcium iodate, Lithol Rubine BK, calcium sulfide, calcium sulfate, calcium phosphate, calcium monohydrogen phosphate, calcium phosphate, tricalcium phosphate, and calcium dihydrogen phosphate.

Examples of the calcium carbonate include FP #300, KS #500, KS #800, KS #1000, KS #1200, ACE #25, SST #40, 7 to 10 mm-white marble, Escalon #200, Escalon #1500, Escalon #2000, and Escalon #2300 manufactured by HAYASHI KASEI CO., LTD.

Examples of the talc include Talcan Powder series, Micron White series, GH series, and KHP series manufactured by HAYASHI KASEI CO., LTD., and NANO ACE series and Ultrafine-Powder Talc series manufactured by NIPPON TALC CO., LTD.

### (Component not Preferably Contained in Inorganic Powder C)

Examples of the component not preferably contained in the inorganic powder C include fatty acid metal salts such as a long-chain fatty acid metal salt. The long-chain fatty acid refers to a fatty acid having 13 or more carbon atoms. Examples of the fatty acid include stearic acid, lauric acid, and palmitic acid. Examples of the metal salt include a magnesium salt, a calcium salt, a zinc salt, a lithium salt, and a barium salt. In particular, it is preferable that the surface of the inorganic powder does not have a long-chain fatty acid metal salt.

Specific examples of the long-chain fatty acid metal salt include metal salts of stearic acid such as magnesium stearate, calcium stearate, and zinc stearate, magnesium laurate, and calcium palmitate. When a fatty acid metal salt such as a long-chain fatty acid metal salt is present on the surface of the inorganic powder C, the pH tends to decrease, and the pH tends to deviate from a range of 6.5 to 11.5.

### (Component not Preferably Contained in Composition)

The composition preferably does not contain an inorganic powder having a pH as evaluated in accordance with JIS M 8016-1991 of less than 6.5 or more than 11.5.

### (Particle Size of Inorganic Powder C: Median Diameter D50 as Measured by Laser Diffraction Method)

The median diameter D50 of the inorganic powder C may be 30 μm or less, 25 μm or less, or 20 μm or less, from the viewpoint of improving mechanical strength such as a flexural modulus. When D50 is too large, mechanical strength such as a flexural modulus is likely to decrease.

The median diameter D50 of the inorganic powder C may be 0.05 μm or more, 0.5 μm or more, 1 μm or more, or 5 μm or more, from the viewpoint of improving mechanical strength such as a flexural modulus.

The median diameter D50 can be determined by measuring a weight-based particle size distribution according to JIS R 1629 using a laser diffraction particle size distribution measuring apparatus to obtain a cumulative particle size distribution curve, and reading out a particle size of 50 wt % of a cumulative amount from the cumulative particle size distribution curve. Examples of the laser diffraction particle size distribution measuring apparatus include MT-3300EX-II manufactured by NIKKISO CO., LTD.

$$( MFR ( X ) / MFR ( B ) )$$

When a melt mass flow rate of the aliphatic polyester-based polymer B as measured under conditions of a temperature of 210° C. and a load of 2.16 kgf is designated as MFR (B), and
a melt mass flow rate of a mixture X containing 0.5 parts by mass of the inorganic powder C with respect to 100 parts by mass of the total of the aliphatic polyester-based polymer B and the inorganic powder C as measured under conditions of a temperature of 210° C. and a load of 2.16 kgf is designated as MFR (X), MFR (X)/MFR (B) preferably satisfies 1.0 or less.

When the aliphatic polyester-based polymer B is deteriorated by the addition of the inorganic powder C, the MFR (X) is larger than the MFR (B). When the deterioration of the aliphatic polyester-based polymer B is suppressed by the addition of the inorganic powder C, the MFR (X) is smaller than the MFR (B). That is, the phrase “MFR (X)/MFR (B) is 1.0 or less” means that the inorganic powder C is a compound that hardly causes significant deterioration of the aliphatic polyester-based polymer B due to heating.

### (Additive)

The composition may contain an additive as necessary. The additive can be at least one selected from the group consisting of a stabilizer, an anti-bacterial agent, an anti-fungal agent, a dispersing agent, a plasticizer, a flame retardant, a tackifier, a colorant, a metal powder, an organic powder, an inorganic fiber, an organic fiber, an organic and inorganic composite fiber, an inorganic whisker, and a filler.

Examples of the stabilizer include at least one selected from the group consisting of a lubricant, an anti-aging agent, a heat stabilizer, a light resistance agent, a weathering agent, a metal deactivator, an ultraviolet absorber, a light stabilizer, and a copper inhibitor. Examples of the light resistance agent include a hindered amine-based light resistance agent.

Examples of the colorant include at least one selected from the group consisting of titanium oxide, carbon black, and an organic pigment. Examples of the metal powder include ferrite.

Examples of the organic powder include a protein. Examples of the inorganic fiber include a glass fiber and a metal fiber. Examples of the organic fiber include a carbon fiber and an aramid fiber. Examples of the inorganic whisker include potassium titanate whisker.

Examples of the filler include at least one selected from the group consisting of ebonite powder, cotton flock, cork powder, cellulose powder, and wood powder.

The composition may contain only one of the above additives, and may contain a combination of two or more kinds thereof.

### (Constitution of Composition)

The contents of the olefin-based polymer A and the aliphatic polyester-based polymer B are not particularly limited with respect to 100 parts by mass of the total of the olefin-based polymer A and the aliphatic polyester-based polymer B, but from the viewpoint of enhancing the mechanical strength such as a flexural modulus, the content of the olefin-based polymer A may be 51 to 99.9 parts by mass and the content of the aliphatic polyester-based polymer B may be 0.1 to 49 parts by mass.

The content of the olefin-based polymer A may be 60 parts by mass or more, 70 parts by mass or more, 80 parts by mass or more, or 90 parts by mass or more with respect to 100 parts by mass of the total of the olefin-based polymer A and the aliphatic polyester-based polymer B.

The content of the inorganic powder C is not particularly limited with respect to 100 parts by mass of the total of the olefin-based polymer A and the aliphatic polyester-based polymer B, but is preferably 0.01 to 40 parts by mass. The content of the inorganic powder C may be 0.1 parts by mass or more or 1 part by mass or more, and may be 20 parts by mass or less.

The total proportion of the olefin-based polymer A, the aliphatic polyester-based polymer B, and the inorganic powder C in the entire composition may be 20 mass % or more, 30 mass % or more, 40 mass % or more, 50 mass % or more, 60 mass % or more, 70 mass % or more, 80 mass % or more, or 90 mass % or more.

The olefin-based polymer A can account for more than 50 mass % of the composition, and can account for 60 mass % or more, 70 mass % or more, 80 mass % or more, or 90 mass % or more.

The aliphatic polyester-based polymer B may account for 0.1 to 20 parts by mass of the composition.

### Effects

According to the composition of the present embodiment, generation of odor is suppressed by containing the inorganic powder C having a specific pH. The reason for this is not clear, but is considered to be, for example, suppression of thermal decomposition of the aliphatic polyester-based polymer B.

Furthermore, when the composition ratio of the olefin-based polymer A and the aliphatic polyester-based polymer B is in a specific range and the median diameter D50 of the inorganic powder C is in the above-described specific range, the mechanical strength such as a flexural modulus (FM) of a molded article further increases. The reason for this is not clear, but it is considered that the inorganic powder C can suppress not only thermal decomposition of the aliphatic polyester-based polymer B but also thermal decomposition of the olefin-based polymer A during molding (melt-kneading).

### (Method for Producing Composition)

The composition can be obtained by melt-kneading each raw material component.

The kneading temperature (set temperature of a kneader) is preferably 150 to 300° C. and more preferably 170° C. to 280° C. It is possible to perform processing at 210° C. or higher.

The composition can be produced by melt-kneading all of the olefin-based polymer A, the aliphatic polyester-based polymer B, the inorganic powder C, and an additive added as necessary at once.

The composition may be produced by a first step of first melt-kneading some of the olefin-based polymer A, all of the aliphatic polyester-based polymer B, some or all of the inorganic powder C, and some or all of the additive added as necessary to produce a preliminary composition, and then a second step of melt-kneading the preliminary composition with the remaining olefin-based polymer A, the remaining inorganic powder C, and the remaining of the additive added as necessary. In the first step, the olefin-based polymer may not be added at all.

The inorganic powder C is preferably added in the first step.

### (Method for Producing Molded Body of Composition)

A molded body of the above-described composition having a desired shape can be obtained by using a known resin molding method such as an injection molding method, an extrusion molding method, a vacuum molding method, a compressed air molding method, a press molding method, a foam molding method, a blow molding method, or a rotation molding method.

Furthermore, the above-described composition can be bonded to other materials such as other resins, metals, paper, and leather to provide a multi-layer structure.

The surface of a molded body of the composition of the present invention may be subjected to a surface treatment. Examples of the surface treatment method include methods such as embossing treatment, corona discharge treatment, flame treatment, plasma treatment, and ozone treatment.

The above-described composition can be widely used as a resin material.

Examples of use applications of the resin composition of the present invention include fiber materials, external structural members, furniture and interior decorative members, household electric appliance members, toy members, gardening members, automobile members, and packaging materials. Examples of the fiber materials include a clothing fabric member, an interior fabric member, and an industrial fiber member, examples of the external structural members include a carport member, a fence member, a gate door member, a gate pillar member, a post member, a cycle port member, a deck member, a sunroom member, a roof member, a terrace member, a handrail member, a shade member, and an awning member, examples of the furniture and interior decorative members include a sofa member, a table member, a chair member, a bed member, a chest member, a cabinet member, and a dresser member, examples of the household electrical appliance members include a member for a watch, a mobile phone member, and a white home electric appliance member, examples of the toy members include a member for a plastic model, a member for a diorama, and a member for a video game main body, examples of the gardening members include a member for a planter, a member for a vase, and a member for a flowerpot, examples of the automobile members include a bumper material, an instrument panel material, and an airbag cover material, and examples of the packaging materials include a food packaging material, a packaging material for fiber, and a packaging material for miscellaneous goods. Further, examples of other use applications include monitor members, office automation (OA) equipment members, medical members, drainage pans, toiletry members, bottles, containers, snow remover members, and various building members.

### EXAMPLES

Hereinafter, the present invention will be described using Examples and Comparative Examples. The olefin-based polymer A, the aliphatic polyester-based polymer B, and the inorganic powder C used in Examples and Comparative Examples are shown below.

### (1) Olefin-Based Polymer A

### (A-1) Propylene Homopolymer

MFR (230° C., 2.16 kg load): 7 g/10 min
Melting point (Tm): 163° C.

### (2) Aliphatic Polyester-Based Polymer B

(B-1) Poly(3-hydroxybutyrate-co-3-hydroxyhexanoate)
Structural formula: formula (BI-3)
Content (mol %) of comonomer (3HH) component: 0.4 mol %
Weight average molecular weight (Mw): 397800
MFR (190° C., 2.16 kg load): 8 g/10 min
MFR (B-1) (210° C., 2.16 kg load): 171 g/10 min
Melting point (Tm): 175° C.

### (3) Inorganic Powder C

### (C-1) Talc

Product name: NANO ACE D-600 manufactured by NIPPON TALC CO., LTD.
pH: 9.0
Particle size D50:0.6 μm

### (C-2) Talc

Product name: NANO ACE FG-15 manufactured by NIPPON TALC CO., LTD.
pH: 8.7
Particle size D50:1.5 μm

### (C-3) Talc

Product name: Micron White TT-H manufactured by HAYASHI KASEI CO., LTD.
pH: 8.7
Particle size: 4.8 μm

### (C-4) Wollastonite

Product name: Wollastonite VN-8N manufactured by HAYASHI KASEI CO., LTD.
pH: 9.9
Particle size: 11.0 μm

### (C-5) Kaolinite

Product name: PoleStar450 manufactured by HAYASHI KASEI CO., LTD.
pH: 5.9
Particle size: 1.5 μm

### (C-6) Kaolinite

Product name: GlomaxLL manufactured by HAYASHI KASEI CO., LTD.
pH: 6.2
Particle size: 1.5 μm

Physical properties of each polymer, inorganic powder, and composition were measured according to the methods described below.

### (1) Melt Mass Flow Rate (MFR, Unit: G/10 Min)

It was measured according to the method specified in JIS K7210-2014. The measurement temperature was 230° C., 210 or 190° C., and the load was 2.16 kg. A cylinder to be melt-kneaded is made of metal, and the resin is not irradiated with light.

The MFR (X) is a melt mass flow rate of a mixture X containing 0.5 parts by mass of any of the inorganic powders C-1 to C-5 with respect to 100 parts by mass of the total of the polymer B-1 and any of the inorganic powders C-1 to C-5, as measured at a temperature of 210° C. and a load of 2.16 kgf.

The MFR (B-1) is a melt mass flow rate of the polymer B-1 as measured under the conditions of a temperature of 210° C. and a load of 2.16 kgf.

### (2) Weight Average Molecular Weight (Mw)

The weight average molecular weight (Mw) was calculated based on the measurement result of gel permeation chromatography (GPC). In the measurement of GPC, GPC-150C manufactured by Waters Corporation was used as a measuring device, an ortho-dichlorobenzene solution having a polymer concentration of 0.05 wt % was used, a mixed polystyrene gel column (PSKgelGMH6-HT manufactured by Tosoh Corporation) was used as a column, and the measurement temperature was 135° C.

### (3) Melting Point (Tm) of Polymer

It was measured according to the method specified in JIS K7121. The measurement temperature was −50° C. to 200° C. or −50° C. to 250° C., and the temperature increasing rate was 10° C./min.

### (4) Content of Comonomer Component of Aliphatic Polyester-Based Polymer B

The content of the comonomer component is the molar ratio of another repeating unit (3-hydroxyhexanoate (3HH) or 4-hydroxybutyrate (4HB)) except 3-hydroxybutyrate to the number of total ester repeating units of the hydroxyalkanoate of the aliphatic polyester-based polymer B.

The content of the comonomer component was determined using the 1H-NMR spectrum described in L. Tripathi., M. C. Factories, 11, 44 (2012).

### [Measurement Conditions]

Model: Bruker AVANCE600
Probe: 10 mm cryoprobe
Measurement temperature: 135° C.
Pulse repetition time: 1 sec
Pulse width: 45° Number of integrations: 700 times
Magnetic field strength: 600 MHz

### (5) Flexural Modulus (FM)

Injection molding was performed at a molding temperature of 220° C. and a mold temperature of 50° C. using SI30III type injection molding machine manufactured by Toyo Machinery & Metal Co., Ltd. to obtain a bending test piece having a size of 4 mm in thickness, 10 mm in width, and 80 mm in length. The flexural modulus (unit: MPa) at 23° C. was measured under the measurement conditions according to JIS-K-7171.

### (6) Detection Amount

Injection molding was performed at a molding temperature of 220° C. and a mold temperature of 50° C. using SI30III type injection molding machine manufactured by Toyo Machinery & Metal Co., Ltd. to obtain a bending test piece having a size of 4 mm in thickness, 10 mm in width, and 80 mm in length. 50 g of the obtained bending test piece was weighed and cut into a width of 4 mm. The cut test piece was put in a polyethylene bag, sealed, and heated in an oven at 40° C. for 2 hours. A gas detector (GV-100) manufactured by GASTEC CORPORATION equipped with a gas detection tube (81 L: acetic acid) manufactured by GASTEC CORPORATION was inserted into a polyethylene bag containing the heated sample, and the detection amount (unit: ppm) was evaluated. The higher the detection amount is, the stronger the odor of the test piece is.

### (7) pH of Inorganic Powder

Regarding the pH of the inorganic powder, 20 g of the inorganic powder was added to 80 mL of pure water and stirred according to JIS M 8016-1991, and the pH of the liquid was evaluated using LAQUAtwin manufactured by HORIBA Advanced Techno, Co., Ltd.

### Example 1

5.0 mass % of the polymer (B-1), 85 mass % of the polymer (A-1), and 10.0 mass % of the inorganic powder (C-1) were mixed, and the mixture was melt-kneaded using a 15 mm twin screw extruder KZW15-45 MG (manufactured by Technovel Corporation) under the conditions of a cylinder setting temperature of 210° C., a screw rotation speed of 500 rpm, and an extrusion amount of about 4 kg/hr to obtain a resin composition (Q-1).

### Example 2

A resin composition (Q-1) was obtained in the same manner as in Example 1, except that the inorganic powder (C-2) was used.

### Example 3

A resin composition (Q-1) was obtained in the same manner as in Example 1, except that the inorganic powder (C-3) was used.

### Example 4

A resin composition (Q-1) was obtained in the same manner as in Example 1, except that the inorganic powder (C-4) was used.

### Comparative Example 1

A resin composition (Q-1) was obtained in the same manner as in Example 1, except that the inorganic powder (C-5) was used.

### Comparative Example 2

A resin composition (Q-1) was obtained in the same manner as in Example 1, except that the inorganic powder (C-6) was used. The results are shown in Table 1.

TABLE 1

| | | | Example | Example | Example | Example | Comparative | Comparative |
|---|---|---|---|---|---|---|---|---|
| | | | 1 | 2 | 3 | 4 | Example 1 | Example 2 |
| Composition | Olefin- | Type | A-1 | A-1 | A-1 | A-1 | A-1 | A-1 |
| | based | mass % | 85 | 85 | 85 | 85 | 85 | 85 |
| | polymer A | | | | | | | |
| | Aliphatic | Type | B-1 | B-1 | B-1 | B-1 | B-1 | B-1 |
| | polyester- | mass % | 5 | 5 | 5 | 5 | 5 | 5 |
| | based | | | | | | | |
| | polymer B | | | | | | | |
| | Inorganic | Type | C-1 | C-2 | C-3 | C-4 | C-5 | C-6 |
| | powder C | mass % | 10 | 10 | 10 | 10 | 10 | 10 |
| | | pH | 9.0 | 8.7 | 8.7 | 9.9 | 5.9 | 6.2 |
| | | Particle size μm | 0.6 | 1.5 | 4.8 | 11.0 | 1.5 | 1.5 |
| | | MFR(X) | 157.4 | 188.7 | 164.2 | 212.6 | 189.0 | 204.5 |
| | | MFR(X)/MFR(B-1) | 0.92 | 1.10 | 0.96 | 1.24 | 1.11 | 1.20 |
| Evaluation of | Acetic acid | ppm | 0.5 | 1.0 | 0.5 | 2.5 | 5.0 | 5.0 |
| composition | detection | | | | | | | |
| | amount | | | | | | | |
| | Flexural | MPa | 2359 | 2384 | 2525 | 1975 | 2143 | 2033 |
| | modulus | | | | | | | |
| | (FM) | | | | | | | |

In Examples 1 to 4 using the inorganic powders C₁ to C₄ having a pH in a range of 6.5 to 11.5, the detection amount was smaller than those in Comparative Examples 1 and 2. In particular, in Examples 1 to 3 having a pH of 9.5 or less, the detection amount was particularly small.

1. A composition comprising: an olefin-based polymer A; an aliphatic polyester-based polymer B; and an inorganic powder C, wherein a pH of the inorganic powder C as evaluated in accordance with JIS M 8016-1991 is 6.5 to 11.5.

2. The composition according to claim 1, wherein the inorganic powder C does not contain a fatty acid metal salt.

3. The composition according to claim 1, wherein the aliphatic polyester-based polymer B is a poly(3-hydroxyalkanoate)-based polymer having a melting point of 150° C. or higher.

4. The composition according to claim 1, wherein the pH of the inorganic powder C as evaluated in accordance with JIS M 8016-1991 is 8.5 to 9.5.

5. The composition according to claim 1, wherein a median diameter D50 of a weight-based particle size distribution of the inorganic powder C as measured by a laser diffraction method is 0.05 to 30 μm.

6. The composition according to claim 1, wherein a content of the olefin-based polymer A is 51 to 99.9 parts by mass and a content of the aliphatic polyester-based polymer B is 0.1 to 49 parts by mass with respect to 100 parts by mass of a total of the olefin-based polymer A and the aliphatic polyester-based polymer B.

7. The composition according to claim 1, wherein a content of the inorganic powder C is 0.1 to 40 parts by mass with respect to 100 parts by mass of a total of the olefin-based polymer A and the aliphatic polyester-based polymer B.

8. The composition according to claim 1, wherein a content of the aliphatic polyester-based polymer B is 0.1 to 20 parts by mass.

9. The composition according to claim 1, wherein the olefin-based polymer A is a propylene-based polymer.

10. The composition according to claim 1, wherein when a melt mass flow rate of the aliphatic polyester-based polymer B as measured under conditions of a temperature of 210° C. and a load of 2.16 kgf is designated as MFR (B), and
a melt mass flow rate of a mixture X containing 0.5 parts by mass of the inorganic powder C with respect to 100 parts by mass of a total of the aliphatic polyester-based polymer B and the inorganic powder C as measured under conditions of a temperature of 210° C. and a load of 2.16 kgf is designated as MFR (X), MFR (X)/MFR (B) is 1.0 or less.
